(19) United States
(12) Patent Application Publication
(10) Pub. No.: US 2004/0156061 A1
(43) Pub. Date: Aug. 12, 2004

(54) Image forming apparatus

(76) Inventor: Hidenori Kobayashi, Sunto (JP)

Correspondence Address: SOCAL IP LAW GROUP, 310 N. WESTLAKE BLVD. STE 120, WESTLAKE VILLAGE, CA, 91362, US

(21) Appl. No.: 10/623,987

(22) Filed: Jul. 21, 2003

Related U.S. Application Data
(60) Provisional application No. 60/447,216, filed on Feb. 12, 2003.

(51) Int. Cl. G06F 3/12; G06F 13/00

(52) U.S. Cl. 358/1.12; 710/19; 358/1.15

(57) ABSTRACT

An image forming apparatus and system are described. An information processing apparatus may select printing paper in a size that is not available on the side of image forming apparatus. When the information processing apparatus executes a print instruction, an error may be caused that stops the print job. In addition, print jobs of other users may be unable to be processed and stopped. To solve this problem, information on the sizes of recording paper that can be fed for image forming is communicated to the information processing apparatus and/or other parts of the system. This information may be received prior to the information processing apparatus transmitting print data to the printer. Thus, whether paper availability may be determined before transmitting print data, and appropriate corrective steps take to avoid delays.

### RELATED APPLICATION INFORMATION

This application claims priority from Provisional Application No. 60/447,216, filed Feb. 12, 2003 entitled “Image Forming Apparatus,” which application is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to an information forming apparatus that executes image forming based on the instructions from an information processing apparatus.

2. Description of Related Art

Conventionally, the sizes of printing paper that can be selected from an application that is stored in an information processing apparatus can be selected within the paper sizes that can be dealt with by the image forming apparatus, and a proper size has been chosen among these sizes accordingly and printing has been done.

However, it is unknown whether printing paper of the specified size is ready on the side of the image forming apparatus when the size is selected.

In such a case, conventionally, a message comprising error description, user name, and job number has been displayed on the operation panel display to urge user to process.

### DESCRIPTION OF THE DRAWINGS

FIG. 1 is a diagram of a system topology compatible with the invention.

FIG. 2 is a functional block diagram of an image forming apparatus in accordance with invention.

FIG. 3 is a flow chart of a printing process in accordance with invention.

FIG. 4 is a flow chart of a part of a printing process in accordance with invention.

FIG. 5 is a flow chart of a confirmation process in accordance with invention.

FIG. 6 is a flow chart of a process after sending print data in accordance with invention.

FIG. 7 is a flow chart of a process of a print driver in accordance with the invention.

### DETAILED DESCRIPTION OF THE INVENTION

Throughout this description, the embodiments and examples shown should be considered as exemplars, rather than limitations on the apparatus and methods of the present invention.

Using an image forming apparatus by this invention, information on sizes of recording paper that can be fed for image forming can be transmitted to an information processing apparatus according to requests from the information processing apparatus, which enables determining whether image forming on paper of the desired size is possible or not before transmitting print data. This enables to avoid problems such as the printing operation or other printing operations directed afterward are stopped because the paper of the specified size is not available.

Recent developments of network increase the chances of sharing one printer among multiple users, and also prevalence of Internet increases the chances of receiving document as electronic files from abroad. However, standard sizes of printing paper vary from country to country, so such problems are increasing at a great rate compared with the past. When such problems occur, conventionally a message of error description has been displayed on the operation panel display to urge users to solve the problem, but printing jobs of other users will be stopped until a user does the actual processing if the printer is shared through network.

Also, when other users notice the problem of the image forming apparatus, they could not determine properly how to deal with the problem with jobs of other users.

Based on this aforementioned situation, this invention intends to provide apparatuses and methods that avoid the status in which an information processing apparatus selects printing paper in a size that is not available on the side of image forming apparatus and executes print instruction, causing an error that stops the printing job, and printing jobs of other users are unable to be processed and stopped until this error is solved, and therefore enables efficient use of the image forming apparatus.

In order to achieve the aforementioned purpose, this invention features a paper feeding means that is formed so that it can feed multiple kinds of recording paper in different sizes, a detecting means that detects whether the recording paper of the specified size is available on the aforementioned paper feeding means, a recognition means that recognizes the size of the recording paper that is fed from the aforementioned paper feeding means, and a transmitting means that transmits the information on the sizes of recording paper that can be fed for image forming to the aforementioned information processing apparatus responding to requests from the aforementioned information processing apparatus.

Description of the System

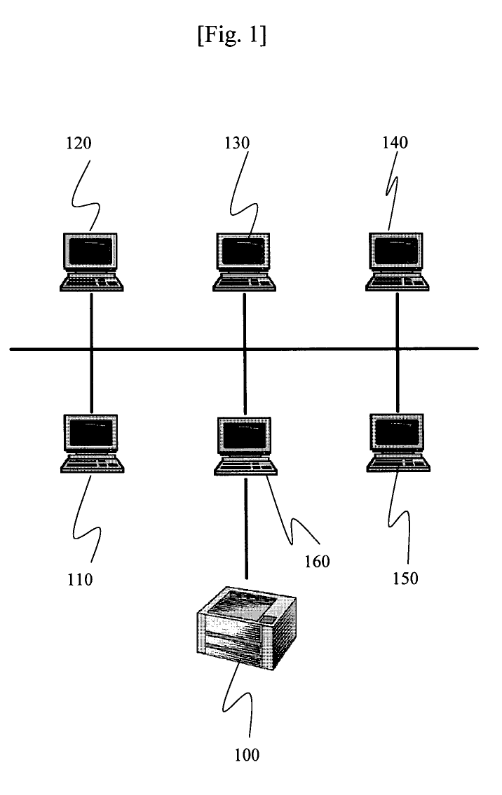

FIG. 1 is shows a system topology compatible with the invention. The system includes an image forming apparatus, 100, multiple information processing apparatuses 110, 120, 130, 140, 150, and a print server 160. A network may interconnect the devices of the system.

The image forming apparatus 100 may be a printer, multifunction peripheral (MFP), or similar device which forms images on output media. The image forming apparatus 100 can generate output on the output media in response to instructions for forming the images on the output media. These instructions will be referred to herein as a “print job,” though the term is not intended to be limited to printed output. Thus, the image forming apparatus 100 may execute printing when it receives print instructions for a print job.

The system may include more than one image forming apparatuses. Although shown connected to the print server 160, the image forming apparatus may be directly connected the network.

The information processing apparatuses 120, 130, 140, 150 may be general purpose or special purpose computing devices. An information processing apparatus in accordance with the invention may be computing devices such as workstations, personal computers, servers, portable computers, personal digital assistants (PDAs), computing tablets, and the like. In addition, the information processing apparatuses may include appliances such as refrigerators, washing machines, and the like as well as residential or commercial HVAC systems, alarm systems, and any other devices or systems capable of communicating over a network. The image forming apparatuses 120, 130, 140, 150 may have applications that create print data, printer driver programs to control the image forming apparatuses, and programs that enable network communication.

The print server 160 may be configured so that it receives print information that may be sent to it from the information processing apparatuses 120, 130, 140, and 150. The print server 160 may be connected to and therefore support one or more image forming apparatuses. The print server 160 receives print information sequentially, temporarily stores it, and may send the print information that is stored in it to the attached printers. The print server 160 may send print information to the attached printers in order received, based on the status of the printer process, and may also be able to change the order based upon prioritization schema.

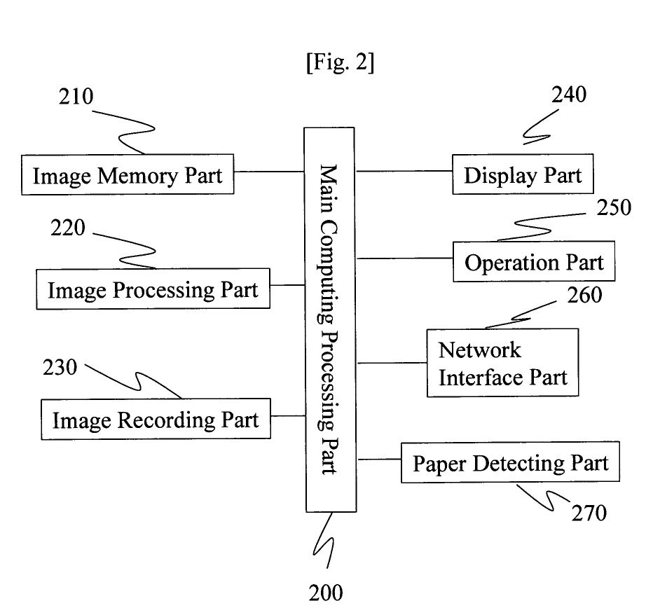

FIG. 2 is a functional block diagram the image forming apparatus 100 (FIG. 1). The printer may include a main computing processing part 200, an image memory part 210, an image processing part 220, an image recording part 230, a display part 240, an operation part 250, a network interface part 260 and a paper detecting part 270. The main computing processing part 200 generally controls the other parts of the image forming apparatus.

The image memory part 210 temporarily stores print information that is sent to the image forming apparatus. The image processing part 220 processes the received print information so that the image forming apparatus can handle it. The image recording part 230 records print information that the image processing part 220 processed on recording paper or other media as a visible image. The display part 240 and operation part 250 display the status of the image forming apparatus and configuration information to the operator, and can accept input from the operator to change various settings of the image forming apparatus. The network interface part 260, which is connected to external equipment such as a print server or an information processing apparatus, controls reception of instructions and print information from external equipment, and transmission of responses to instructions and print information.

The paper detecting part 270 is set to the paper feeder in the image recording part 230. This paper detecting part 270 (hereinafter referred to as paper sensor) detects whether recording paper is set within the paper feeder and sends the information to the main computing processing part 200. Usually, multiple paper feeders are set in the image recording part 230 and paper of different sizes are set in each of them. A configuration like this omits changing recording paper and enables feeding multiple kinds of paper, which enables to provide high-productivity printers.

Also, some paper sensors not only detect whether there is paper, but also have paper size sensors to detect the paper size in each paper feeder. These paper size sensors often adopt a controlling method to detect the position of the paper guide in the paper feeder to determine the paper size, or a controlling method to detect the parts that have different shapes for each paper size.

To have paper size sensors as described above may have many problems related to cost. Therefore, the paper size set to each paper feeder may be set from the operation part 250. When setting from the operation part 250, by setting paper types (for example, recycled paper, bond paper, colored paper, etc.) other than paper sizes, accurate paper selection is available for print instructions with paper type specifications from the information processing apparatus.

Setting from the operation part 250 eliminates the need to set sensors. On the other hand, this may be a problem because operators have more burdens.

Description of the Methods

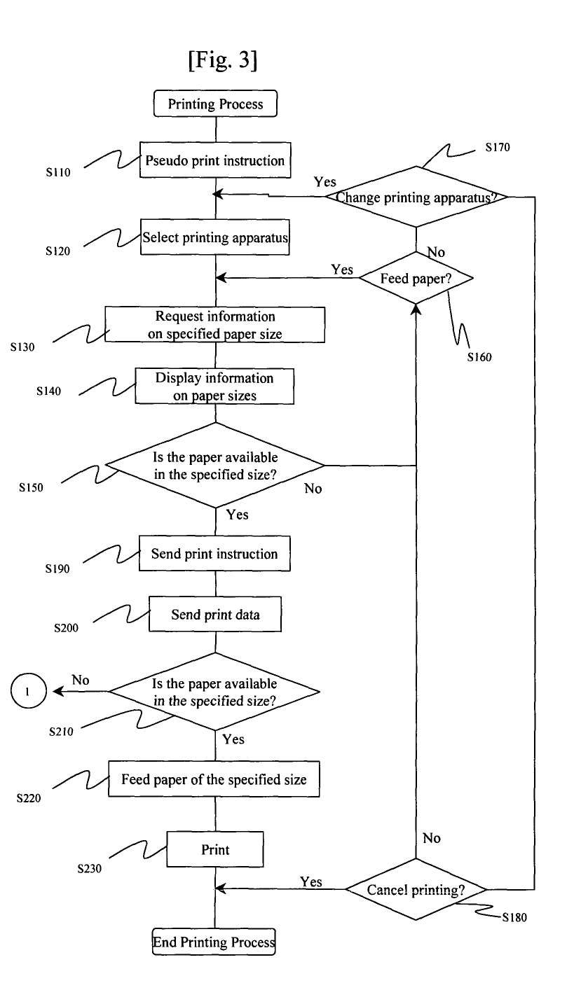

FIG. 3 is a flow chart that shows a print processing routine in accordance with the invention. The information processing apparatus transmits a pseudo print instruction (step S110). When the pseudo print instruction is transmitted, the image forming apparatus becomes selectable (step S120). When the image forming apparatus is selected, a signal to request the available paper is transmitted to the selected image forming apparatus (step S130). When the image forming apparatus receives the request for paper information, the image forming apparatus sends the requested information to the information processing apparatus that requested the information. The information from the image forming apparatus is received and analyzed, and the information on the available paper may be displayed by the information processing apparatus (step S140).

The specified paper may be unavailable for at least three reasons. First, the image forming apparatus may lack a paper tray designated for handling the specified paper size or type. Second, while there may be an appropriate paper tray, the paper tray may be empty. Third, while there may be an appropriate paper tray, the paper tray may actually have a different kind of paper than that designated.

If the specified paper is not initially available (step S150), the information processing apparatus determines whether paper is subsequently available (e.g., manually fed or loaded) or not (step S160).

If paper has become available, the information process apparatus requests the paper information again to determine if the specified paper has become available. If the paper is not available, the information processing apparatus determines whether the image forming apparatus is changed or not (step S170). At this point, a different image forming apparatus may be selected (step S120). If the image forming apparatus is not changed, the information processing apparatus determines whether to cancel the printing or not (step S180). If the printing is canceled, the printing process finishes. On the other hand, when the printing is not canceled, the information processing apparatus determines again whether paper is available or not (step S160).

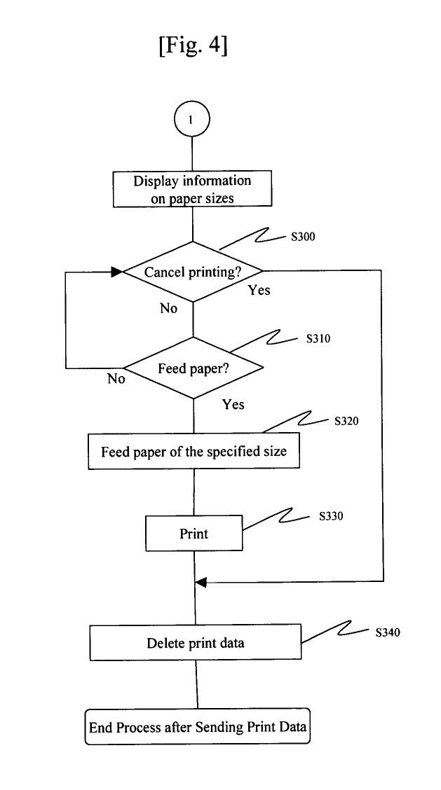

Also, when the specified paper is available in step S150, the information processing apparatus transmits a print instruction (step S190), and the print data is transmitted from the information processing apparatus to the image forming apparatus (step S200). After sending the print data and right before starting printing, the information processing apparatus determines again whether the specified paper is available or not (step S210). If it is not, the process proceeds to FIG. 4. If the specified paper is available, paper is fed (step S220) and printing operation is started (step S230). When all pages are printed, the printing process is finished.

The information on the specified paper size is requested in step S130, and the received information is displayed in step S140. However, information on all kinds of paper that can be fed in the printing apparatus specified in S120 at that time can be requested. In this case, when there is more than one sizes of paper that you want to print on, for example, the information processing apparatus can switch to paper of another size and sends a print instruction to execute printing on the apparatus specified in step S120.

FIG. 4 is a flow chart that shows a processing routine when there is no paper in the specified size after sending print data. When paper is not available after sending print data to the printer, it determines whether to cancel printing or not (step S300). If the printing is canceled, it deletes the print data (step S340) before finishing the process because the print data is already received.

When printing is not canceled in step S300, whether paper is fed or not is determined (step S310). When the paper is not fed, the process returns to step S300 again and whether printing is canceled or not is determined. If paper is fed in step S310, the specified paper is fed (step S320) and the printing is executed (step S330). The process of the flow chart shown in FIG. 4 is a process after print data is transmitted from the information processing apparatus and received by the printer, so changing printing apparatus is not possible.

The reason to check whether there is the specified printing paper right before printing even though it is checked before sending the print data is that the paper of the specified size might be used up if other print data is printed after the print data is sent and before the data is actually printed. Especially, image forming apparatuses connected to a network can receive and process print data from many information processing apparatuses, so aforementioned cases can be happen.

Therefore, checking whether the paper of specified size is available or not is beneficial, and feeding paper or canceling the print job according to the information transmitted from the image forming apparatus is also beneficial.

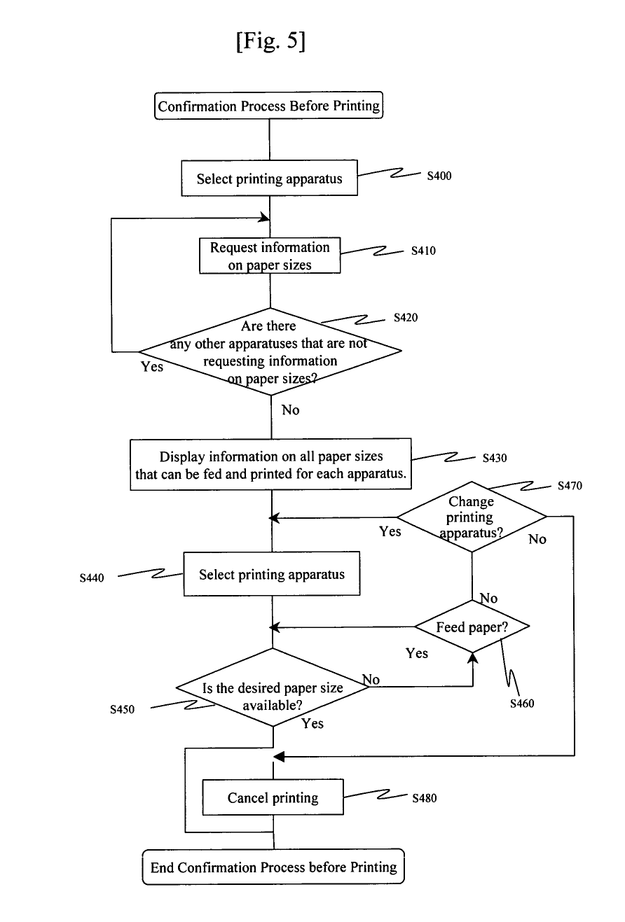

FIG. 5 indicates another embodiment of the process up to the print instruction is transmitted in FIG. 3. In FIG. 3, the image forming apparatus is selected first and then information on the specified paper size is acquired, and the print instruction is issued. On the other hand, in FIG. 5, information on paper sizes on selected multiple image forming apparatuses is acquired first, and then an image forming apparatus is selected and printing is executed.

First, image forming apparatuses to request paper size information are selected (step S400). In this step, at least one image forming apparatus is selected.

In other words, all image forming apparatuses that are expected to be selected as the image forming apparatus can be selected. For the image forming apparatuses that are selected in step S400, paper availability information is requested and received (step S410). The information processing apparatus confirms if paper availability information is requested to all the selected image forming apparatuses, and if there are other image forming apparatuses that it has not requested information, it requests paper availability information to the image forming apparatuses and receives information from each image forming apparatuses (step S420). When information on all the selected image forming apparatuses is received, the paper availability information of the selected image forming apparatuses may be displayed by the information processing apparatus. The information on any image forming apparatus among those selected by the operator can be displayed, or after receiving the paper availability information, it may be automatically displayed sequentially.

From the displayed information on paper availability, the operator may select the image forming apparatus to which the print data is to be output (step S440). After checking whether the paper of the desired size is available in the selected image forming apparatus or not (step S450), the confirmation job before printing is finished if there is paper. If the paper of the desired size is not available in step S450, the information processing apparatus confirms if the paper is fed or not (step S460). If not, the process returns to step S450 again. If paper is not fed in step S460, the information processing apparatus confirms whether to change the image forming apparatus (step S470), and if so, the process returns to step S440 again and another image forming apparatus is selected. If the image forming apparatus is not changed in step S470, the print job is canceled and the confirmation process before printing is finished.

As described above, by getting paper size information from multiple image forming apparatuses before printing and select an image forming apparatus from them to print, the image forming apparatuses that have desired paper can be searched and selected effectively. As a result, failures such as a print job is stopped because specified paper is not available after print instruction is issued can be dramatically decreased.

In S410, information on all paper that can be fed for the selected apparatus is requested. However, the paper can be specified when requesting information. Requesting information on all kinds of paper that can be fed form multiple selected image forming apparatuses can cause a big amount of information to go through network and can be a heavy load. To decrease such load, requesting information on only specified paper may be more effective.

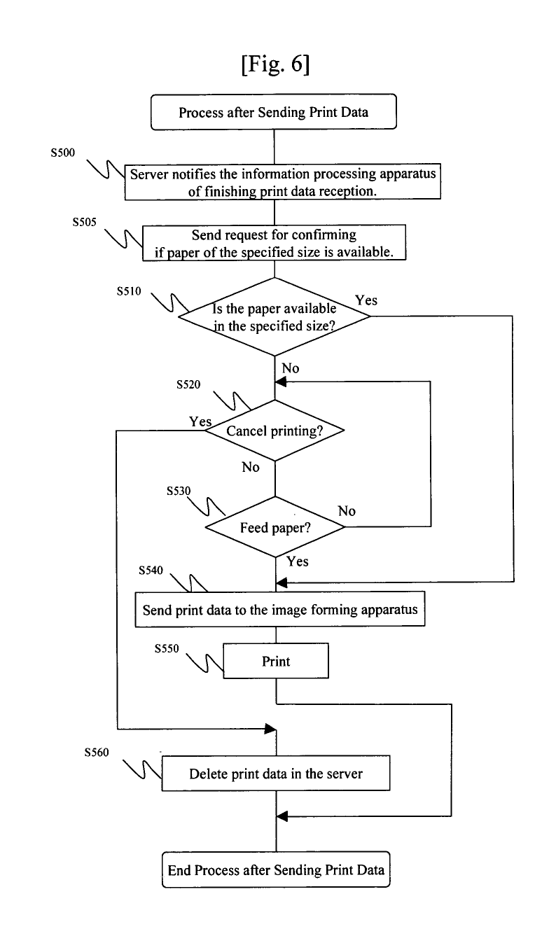

FIG. 6 describes another embodiment of the process after step S200 in FIG. 3. This embodiment describes the process when print data is sent from the information processing apparatus and received by the print server but the print data is not sent to the printer yet.

When print data from the information processing apparatus is received, the server sends the signal that indicates the end of receiving data to the information processing apparatus (step S500). Responding to this, the information processing apparatus transmits a request for confirming whether the paper of the specified size is available or not (step S505). If the paper of the specified size is available, print data is sent to the printer (step S540) and the printing is executed (step S550). If the paper is not available in step S510, the server confirms whether the printing is canceled or not (step S520). If the printing is canceled here, print data in the server is deleted and the process after sending print data is finished. If the printing is not canceled in step S520, the server confirms whether paper is fed or not (step S530). If the paper is fed at this time, printing is executed (step S550). If the paper is not fed, the process returns to step S520 again and whether to cancel the printing is confirmed.

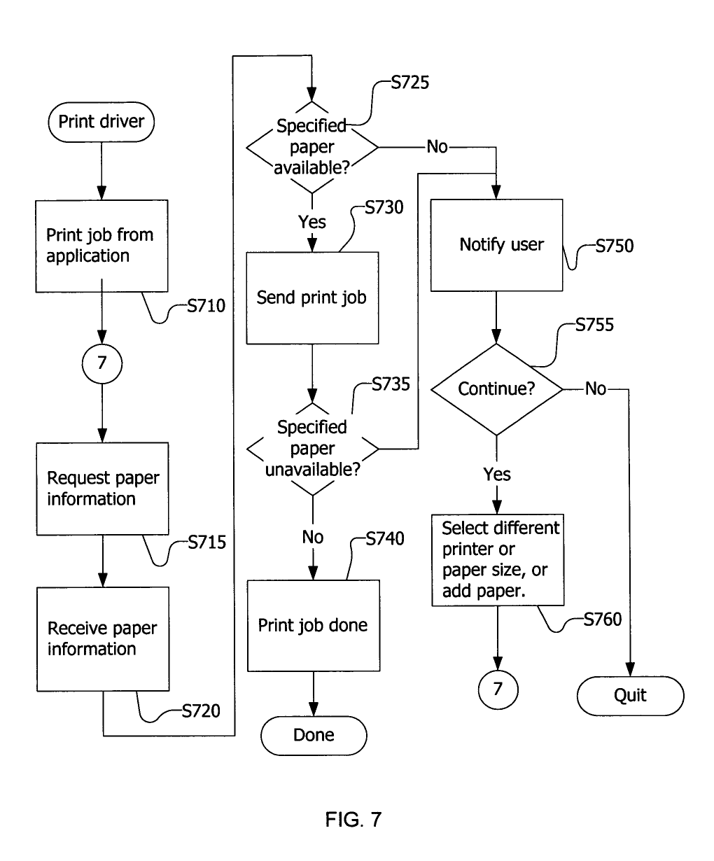

Referring now to FIG. 7, there is shown a flow chart of a process of a print driver in accordance with the invention. The print driver may be installed in an information processing apparatus. The print driver receives print instructions for print jobs, such as from an application program in the information processing apparatus or its operating system (S710). The print instruction includes a selected paper type to be used for the print job and specifies an image forming apparatus to receive the print job. It should be understood that a paper type may be “selected” as a default paper type, and an image forming apparatus may be “specified” as a default image forming apparatus. Thus, by not making a specific selection or specification, a specification or selection is nonetheless made.

Before the print job is sent to the specified image forming apparatus, the print driver may request paper availability information from the specified image forming apparatus (step S715). The print driver subsequently receives the paper availability information from the specified image forming apparatus (step S720). The paper availability information specifies what types of paper are available in the specified image forming apparatus.

If the paper availability information indicates that the specified paper type is unavailable in the specified image forming apparatus (step S725), the print driver may notify the user (step S750), and provide one or more options.

One or more of these options may be provided directly to the user, for example through a dialog box. One or more of these options may be provided to the application program, or to the operating system of the information processing apparatus. The options may include continuing with the print job (step S755), canceling the print job (step S795), or modifying the print instruction (step S760). The options may include having the print driver wait while the image forming apparatus is adjusted, for example to add more paper, or to replace paper, to add a paper tray, or replace a paper tray. An option to select a different image forming apparatus may be provided. These options may be provided together, or separately, such as in different dialog boxes. For example, the option to modify the print instruction is compatible with the option to select a different image forming apparatus, so a user may be permitted to change his paper selection and the selected image forming apparatus.

Before providing the option to select the different image forming apparatus, it may be desirable to first request paper availability information from one or more available image forming apparatuses. The print driver then receives the paper availability information from these other image forming apparatuses. The option to select the different image forming apparatus may be provided only if the paper availability information from the respective other image forming apparatuses indicates that the specified paper type is available in the respective different image forming apparatuses.

If the paper availability information indicates that the specified paper type is available in the image forming apparatus (step S725), the print driver may then send the print job to the image forming apparatus (step S730). If the specified paper subsequently becomes unavailable (step S735), processing may continue at step S750 as discussed above. Otherwise, the print driver may receive a message from the image forming apparatus that the print job is complete (step S740).

By controlling as described above, even after print data is sent to the printer server, the data is sent to the printer after checking whether the paper of specified size is available or not, so failures such as the print job is stopped because paper of the specified size is not available causing other print jobs to be stopped can be avoided.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

It is claimed:

1. An image forming apparatus having capability for forming images based on instructions from an information processing apparatus, the image forming apparatus comprising:
a paper feeder that is formed to enable feeding recording paper of several kinds that are different in size
a first detector that detects whether there is recording paper to be fed to the aforementioned paper feeder
a second detector that recognizes the size of the recording paper that is fed from the aforementioned paper feeder
a transmitter that transmits information on the sizes of recording paper that can be fed for image forming to the information processing apparatus responding to requests from the information processing apparatus.

2. An information processing apparatus connected to an image forming apparatus, the information processing apparatus comprising
an apparatus selecting means that selects an image forming apparatus
a status request means that requests the status of each image forming apparatus
a receiving means that receives the status from each image forming apparatus
a display means that displays the status information of each image forming apparatus that is received by the receiving means
a print instruction means that can issue print instruction based on the status information of the image forming apparatus displayed on the said display means.

3. The information processing apparatus of claim 2, wherein
the apparatus selecting means allows selection of multiple image forming apparatuses
the status request means can request the statuses of the multiple image forming apparatuses that are selected by the apparatus selecting means
the receiving means can receive status information from multiple image forming apparatuses
the display means can display status information form multiple image forming apparatuses.

4. A memory media that stores software to control image forming apparatuses, the software comprising
a selection function that can select at least one of the image forming apparatuses responding to instructions of an application
a configuration function that can configure image-forming conditions of the image forming apparatuses
a request function that requests status information of the image forming apparatuses
a receiving function that receives status information from image forming apparatuses
a display function that displays the received status information.

5. An image forming method of an image forming apparatus that executes image forming operation based on the instructions from an information processing apparatus, which:
receives requests for information on recording paper from an information processing apparatus,
transmits information on recording paper that includes at least information on sizes of recording paper that is available for image forming responding requests from the information processing apparatus, and
receives and executes print instructions from the aforementioned information processing apparatus after transmitting the aforementioned information on recording paper.

6. An image forming instruction method of an image forming apparatus that executes image forming operation based on the instructions from an information processing apparatus, which:
transmits print instruction from an information processing apparatus,
requests information on recording paper to the specified image forming apparatus responding to the transmitted print instruction,
determines whether recording is available or not based on the requested information on recording paper,
sends print information from the information processing apparatus to the image processing apparatus when it determines recording is available, and
notifies the operator that recording is not available when it determines recording is not available.

7. A method of operating an information processing apparatus comprising
receiving a print instruction for a print job, wherein the print instruction includes a selected paper type to be used for the print job and specifies an image forming apparatus to receive the print job
requesting paper availability information from the specified image forming apparatus before the print job is sent to the specified image forming apparatus
receiving the paper availability information from the specified image forming apparatus, wherein the paper availability information specifies what types of paper are available in the specified image forming apparatus
providing options to continue with the print job, to cancel the print job, or to modify the print instruction if the paper availability information indicates that the specified paper type is unavailable in the specified image forming apparatus.

8. The method of operating an information processing apparatus of claim 7 further comprising, sending the print job to the image forming apparatus if the paper availability information indicates that the specified paper type is available in the image forming apparatus.

9. The method of operating an information processing apparatus of claim 7 further comprising, in the providing options step, providing an option to wait while the image forming apparatus is adjusted.

10. The method of operating an information processing apparatus of claim 7 further comprising, in the providing options step, providing an option to select a different image forming apparatus.

11. The method of operating an information processing apparatus of claim 10 wherein the option to modify the print instruction is compatible with the option to select a different image forming apparatus.

12. The method of operating an information processing apparatus of claim 10, wherein, before providing the option to select the different image forming apparatus,
requesting paper availability information from at least one different image forming apparatus
receiving the paper availability information from the respective different image forming apparatuses, wherein the paper availability information specifies what types of paper is available in the respective different image forming apparatuses.

13. The method of operating an information processing apparatus of claim 12, wherein the option to select the different image forming apparatus is only provided if the paper availability information from the respective different image forming apparatuses indicates that the specified paper type is available in the respective different image forming apparatuses.

14. The method of operating an information processing apparatus of claim 12, further comprising providing options to direct the print job to one of the different image forming apparatuses.

15. The method of operating an information processing apparatus of claim 14 wherein the option to modify the print instruction is compatible with the option to select a different image forming apparatus.

16. The method of claim 7 wherein the selected paper type is a default paper type.

17. A computer program product comprising a computer usable medium having computer readable program code embodied therein for causing a processor to
receive a print instruction for a print job which includes a selected paper type to be used for the print job and specifies an image forming apparatus to receive the print job
request paper availability information from the specified image forming apparatus before the print job is sent to the specified image forming apparatus
receive the paper availability information from the specified image forming apparatus, wherein the paper availability information specifies what types of paper are available in the specified image forming apparatus
provide options to continue with the print job, to cancel the print job, or to modify the print instruction if the paper availability information indicates that the specified paper type is unavailable in the specified image forming apparatus.

18. The computer program product of claim 17 having computer readable program code embodied therein for causing the processor to send the print job to the image forming apparatus if the paper availability information indicates that the specified paper type is available in the image forming apparatus.

19. The computer program product of claim 17 having computer readable program code embodied therein for causing the processor to provide an option to wait while the image forming apparatus is adjusted.

20. The computer program product of claim 17 having computer readable program code embodied therein for causing the processor to provide an option to select a different image forming apparatus.

21. The computer program product of claim 20, wherein the option to modify the print instruction is compatible with the option to select a different image forming apparatus.

22. The computer program product of claim 20 having computer readable program code embodied therein for causing the processor to, before the option to select the different image forming apparatus is provided,
request paper availability information from at least one different image forming apparatus
receive the paper availability information from the respective different image forming apparatuses, wherein the paper availability information specifies what types of paper is available in the respective different image forming apparatuses.

23. The computer program product of claim 22 having computer readable program code embodied therein for causing the processor to provide the option to select the different image forming apparatus only if the paper availability information from the respective different image forming apparatuses indicates that the specified paper type is available in the respective different image forming apparatuses.

24. The computer program product of claim 22 having computer readable program code embodied therein for causing the processor to provide options to direct the print job to one of the different image forming apparatuses.

25. The computer program product of claim 24, wherein the option to modify the print instruction is compatible with the option to select a different image forming apparatus.

26. The computer program product of claim 17, wherein the selected paper type is a default paper type.

27. A method of operating a print server coupled to an image forming apparatus, the method comprising
receiving a print job from an information processing apparatus, wherein the print job specifies a paper type to be used for the print job
before the print job is sent to the image forming apparatus
requesting paper availability information from the image forming apparatus
receiving the paper availability information from the image forming apparatus, wherein the paper availability information specifies what types of paper are available in the image forming apparatus
notifying the information processing apparatus if the paper availability information indicates that the specified paper type is unavailable in the image forming apparatus.

28. The method of operating a print server coupled to an image forming apparatus of claim 27 further comprising notifying the information processing apparatus of complete receipt of the print job, after receiving the print job.

29. The method of operating a print server coupled to an image forming apparatus of claim 27 further comprising, after the step of notifying the information processing apparatus, receiving an instruction from the information processing apparatus to continue with the print job, to cancel the print job, or to modify the print job.

30. The method of operating a print server coupled to an image forming apparatus of claim 27 further comprising sending the print job to the image forming apparatus.

31. The method of operating a print server coupled to an image forming apparatus of claim 27 further comprising deleting the print job.

32. A print server coupled to an image forming apparatus, the print server comprising a processor, a communications interface and a computer usable medium having computer readable program code embodied therein for causing the processor to
receive a print job from an information processing apparatus through the communications interface, wherein the print job specifies a paper type to be used for the print job
before the print job is sent to the image forming apparatus
request paper availability information from the image forming apparatus
receive the paper availability information from the image forming apparatus, wherein the paper availability information specifies what types of paper are available in the image forming apparatus
notify the information processing apparatus if the paper availability information indicates that the specified paper type is unavailable in the image forming apparatus.

33. The print server of claim 32, the computer readable program further for causing the processor to notify the information processing apparatus of complete receipt of the print job, after the print job is received.

34. The print server of claim 32, the computer readable program further for causing the processor to receive an instruction from the information processing apparatus to continue with the print job, to cancel the print job, or to modify the print job, after the information processing apparatus is notified.

35. The print server of claim 32, the computer readable program further for causing the processor to send the print job to the image forming apparatus.

36. The print server of claim 32, the computer readable program further for causing the processor to delete the print job.
